(19) United States
(12) Patent Application Publication
(10) Pub. No.: US 2026/0090928 A1
(43) Pub. Date: Apr. 2, 2026

(54) STOWABLE TURN-TO-EXIT RAMP FOR A PASSENGER VEHICLE

(71) Applicant: The Braun Corporation, Winamac, IN (US)

(72) Inventors: Christopher C. Wegner, Winamac, IN (US); Edward Poulos, Westfield, IN (US)

(73) Assignee: The Braun Corporation, Winamac, IN (US)

(21) Appl. No.: 19/295,628

(22) Filed: Aug. 10, 2025

Related U.S. Application Data
(60) Provisional application No. 63/701,072, filed on Sep. 30, 2024.

(51) Int. Cl. A61G 3/06

(52) U.S. Cl. CPC A61G 3/061

(57) ABSTRACT

A wheelchair ramp for providing access to a vehicle for physically limited passengers is provided. The wheelchair ramp may deploy out of a rear entrance to the vehicle and the ramp may have an inclined portion directed towards a side of the vehicle. The wheelchair ramp may have a substantially horizontal platform where a passenger may maneuver and turn to enter or exit the vehicle. The horizontal portion may be substantially level with an interior floor of the vehicle. The wheelchair ramp may have at least one winch system to assist the passenger in traversing the inclined portion.

This application claims priority to provisional U.S. Patent Application No. 63/701,072, filed on September 30, 2024, the contents of which is incorporated by reference.

### FIELD OF THE DISCLOSURE

The present disclosure relates generally to a passenger vehicle that has been modified to allow access by a physically limited passenger, and more particularly to a stowable ramp configured with a turn.

### BACKGROUND

Automobile manufacturers do not currently mass-produce passenger motor vehicles specifically designed to transport passengers having physical limitations, either as a driver or as a non-driving passenger. Consequently, mass-produced passenger vehicles are modified, or retrofitted, by aftermarket companies dedicated to supplying vehicles to physically limited passengers. Such vehicles can be modified by altering or adding certain parts or structures within a vehicle to accommodate the physically limited passenger without inconveniencing other passengers or sacrificing space in the vehicle. For example, in one configuration, a passenger vehicle may be retrofitted with an accessibility device such as a ramp or a lift to enable a physically limited individual using a personal mobility device to enter and exit the vehicle.

Many full-size electric passenger vehicles are modified with a wheelchair lift deployed out of a side or rear entrance to the vehicle. However, mobility passenger feedback has provided insight that it is more comfortable to maneuver a ramp than to be lifted off the ground.

As an alternative to a lift, a ramp may be provided for vehicle access, but regulations govern a maximum wheelchair ramp angle. Vehicle modifiers typically satisfy this regulation by lowering the vehicle floor. Lowering the floor requires extensive modification such as removing the OEM floor and replacing it with a custom lowered floor. Modern electrically powered vehicles often store a battery below the vehicle floor, presenting additionally challenges for the lowered floor method of modification.

As an alternative to lowering the vehicle floor, the ramp angle regulation can also be satisfied by lengthening the ramp. This method of compliance, however, leads to a significant increase in ramp length, which may result in space constraints. Vehicle operators may have difficulty finding enough space to deploy the ramp, as a long ramp deploying out of a rear entrance may block aisles in parking lots. Similarly, a long ramp deploying out of a side entrance may extend beyond the cross-hatch area into an adjacent parking space or block a sidewalk. Accordingly, a long, conventionally-configured ramp will either be practically unusable or will, in use, block other cars and pedestrians.

### SUMMARY OF THE EMBODIMENTS

In one embodiment, an access device may be moveable between a deployed position outside a vehicle and a stowed position adjacent a rear entrance in an interior of the vehicle. The access device may comprise a platform assembly that may be stowed behind or under the passenger seats in an interior of the passenger vehicle and may deploy out of the rear entrance. The platform assembly may be traversed via a path. The path may have a first path portion and a second path portion may be non-parallel to each other and may be separated by a turn.

In one example of this embodiment, the platform assembly may comprise a first platform and a second platform. The first platform may be generally horizontal in the deployed position. The first platform may be hingedly coupled on a first side to a floor of the vehicle. The first platform may be stowed in a generally vertical position behind the passenger seats and configured to rotate about a first axis to the deployed position. A second side of the first platform may be hingedly coupled to a second platform at a second axis. The second axis may be substantially perpendicular to the first axis of the first platform such that the second platform deploys perpendicular to a forward direction of the vehicle.

In another example of this embodiment, the first platform may have one or more supports configured to contact the ground and support the weight of a passenger traversing the access device. The one or more supports may linearly deploy via a telescoping mechanism, linear guide rail mechanism, via a hydraulic or pneumatic cylinder, ball screw mechanism, or any other know method for linearly deploying an object. The one or more support deployment mechanisms may be adjustable such that when they contact the ground to support the first platform in a level position. This ensures the ramp assembly is safe for a passenger to traverse when the vehicle is on unlevel ground.

In another example of this embodiment, a sensor may be coupled to the first platform to ascertain the levelness of the second platform. The sensor may be electrically coupled to a controller that may be electrically coupled to the one or more support deployment mechanisms. The controller may be configured to receive a signal relating to the levelness of the first platform, perform a simple algorithm to determine adjustment of the one or more supports necessary, and send a signal to the one or more support deployment mechanisms to adjust the one or more supports by the calculated amount.

In another embodiment, the one or more supports may may be hingedly coupled to an underside of the first platform. Alternatively, the one or more supports may be hingedly coupled to a side of the first platform. The one or more supports may be a fixed height or may have a manual adjustment for the operator to set a proper height.

In another example of this embodiment, the second platform may be configured to contact the ground such that it is inclined in the deployed position. The second platform may be configured to rotate about the second axis and stow generally perpendicular to the first platform such that the second platform is adjacent a side wall of the vehicle in the stowed position. Alternatively, the second platform may rotate about the second axis such that the second platform stows on top of the first platform. The second platform may be configured to contact the ground at a bottom end such that the second platform is an appropriate angle for a mobility passenger to traverse. The bottom end of the second platform may be supported by the ground. A top end of the second platform may be coupled to the first platform and may be supported by the first platform via the supports such that the second platform is not required to have supports.

In another example of this embodiment, the access device may be folded into a compact package in a housing. The housing may linearly slide out of the rear entrance of the vehicle to deploy the access device. The housing may deploy via linear guide rails, or any other known method of slidingly deploying an object.

In another embodiment, the second platform may include one or more platform sections. The one or more platform sections may be hingedly coupled to each other and configured to fold up in a stowed position.

In another embodiment, the first platform may include a winch system. The winch system may be mounted to the first platform, or may be mounted to a vertical structure on a side of the horizontal portion as to not take up maneuvering room on the first platform. The vertical structure may be opposite of the first platform connection to the second platform. The winch system may be configured to be connected to a personal mobility device and assist the passenger up the second platform. The winch may also be configured to slowly repel a passenger down the second platform when disembarking. The winch system may include one or more winches with connectors configured to attach to a personal mobility device. A plurality of winches may be operated by a singular hand controller. The singular hand controller may include a joystick. The joystick may be configured to adjust the retraction or releasing of each winch in the winch system independently based on directional toggling of the joystick. The winch system may steer a passenger up or down the second platform.

### BRIEF DESCRIPTION OF DRAWINGS

The above-mentioned aspects of the present disclosure and the manner of obtaining them will become more apparent and the disclosure itself will be better understood by reference to the following description of the embodiments of the disclosure, taken in conjunction with the accompanying drawings, wherein:

FIG. 1 is a perspective view of a full-size passenger van with a wheelchair ramp in a fully deployed position.

FIG. 2 is a perspective view of the full-size passenger van with a wheelchair ramp of FIG. 1, with the wheelchair ramp in a partially deployed position.

FIG. 3 is a perspective view of an interior of the full size van with a wheelchair ramp of FIGS. 1-2, with the wheelchair ramp in the stowed position.

FIGS. 4-5 illustrate a side view of the wheelchair ramp in the deployed position.

FIG. 6 illustrates an electronic system for controlling one or more supports of the wheelchair ramp.

Corresponding reference numerals are used to indicate corresponding parts throughout the several views.

It should be understood that the drawings are not necessarily to scale and that the embodiments are sometimes illustrated by graphic symbols, phantom lines, diagrammatic representations and fragmentary views. In certain instances, details which are not necessary for an understanding of the embodiments described and claimed herein or which render other details difficult to perceive may have been omitted. It should be understood, of course, that the inventions described herein are not necessarily limited to the particular embodiments illustrated. Indeed, it is expected that persons of ordinary skill in the art may devise a number of alternative configurations that are similar and equivalent to the embodiments shown and described herein without departing from the spirit and scope of the claims.

### DETAILED DESCRIPTION OF THE EMBODIMENTS

The embodiments of the present disclosure described below are not intended to be exhaustive or to limit the disclosure to the precise forms disclosed in the following detailed description. Rather, the embodiments are chosen and described so that others skilled in the art may appreciate and understand the principles and practices of the present disclosure. Any alterations and further modifications in the described embodiments and any further applications of the principles of the inventions as described herein are contemplated as would normally occur to one skilled in the art. Although a limited number of embodiments are shown and described, it will be apparent to those skilled in the art that some features that are not relevant to the claimed inventions may not be shown for the sake of clarity.

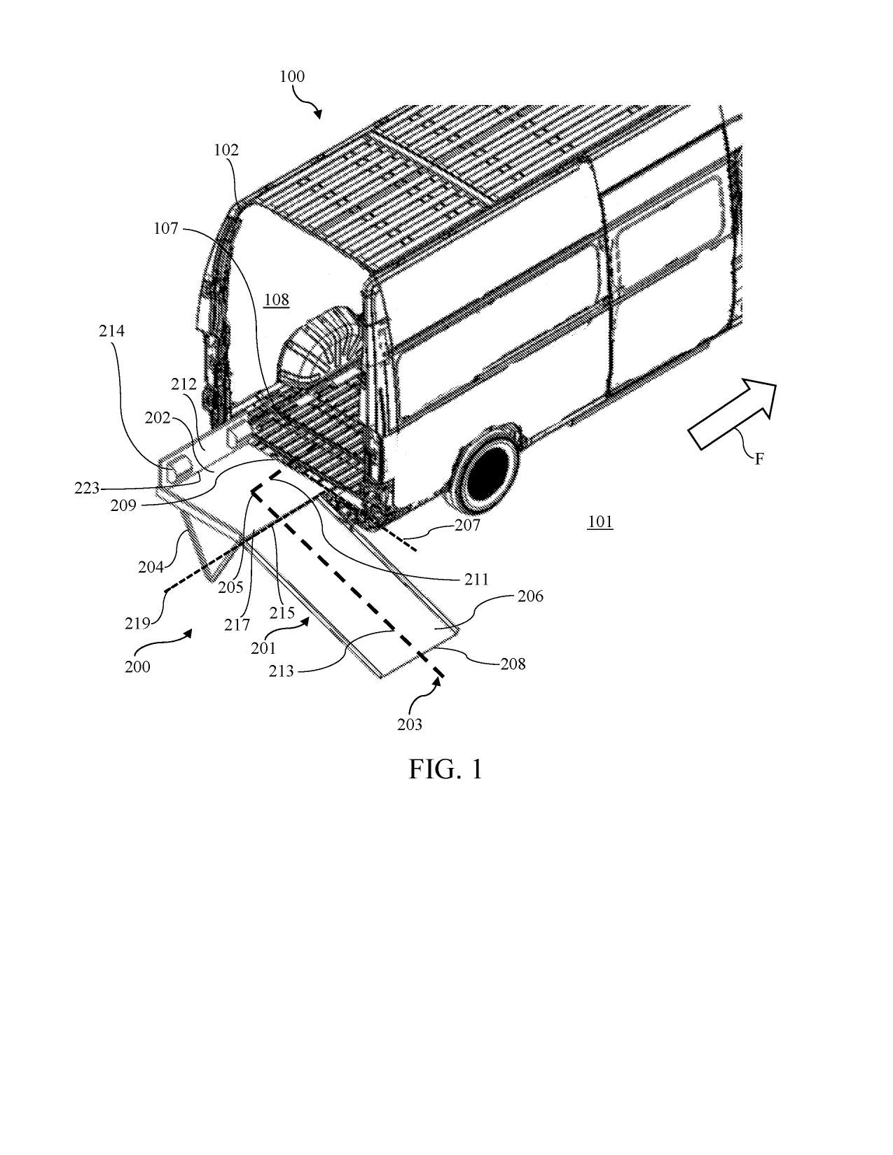

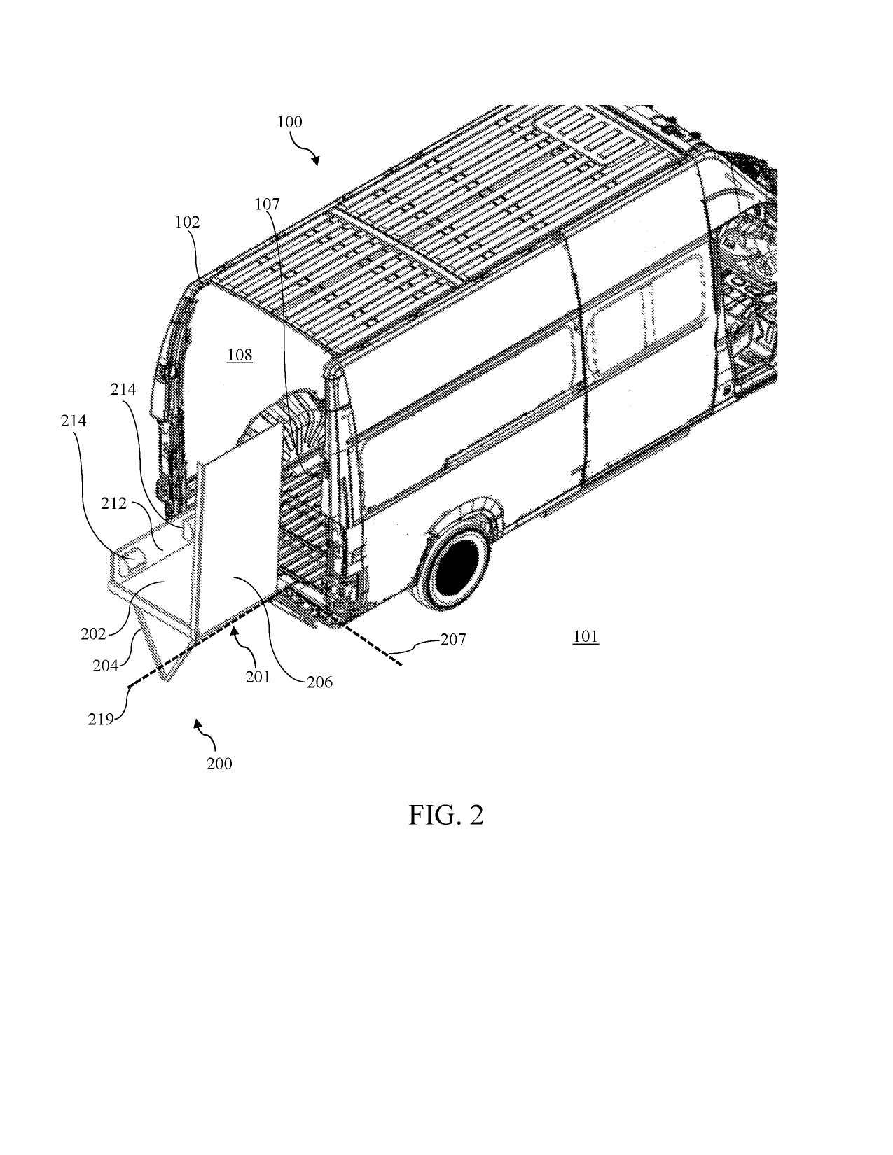

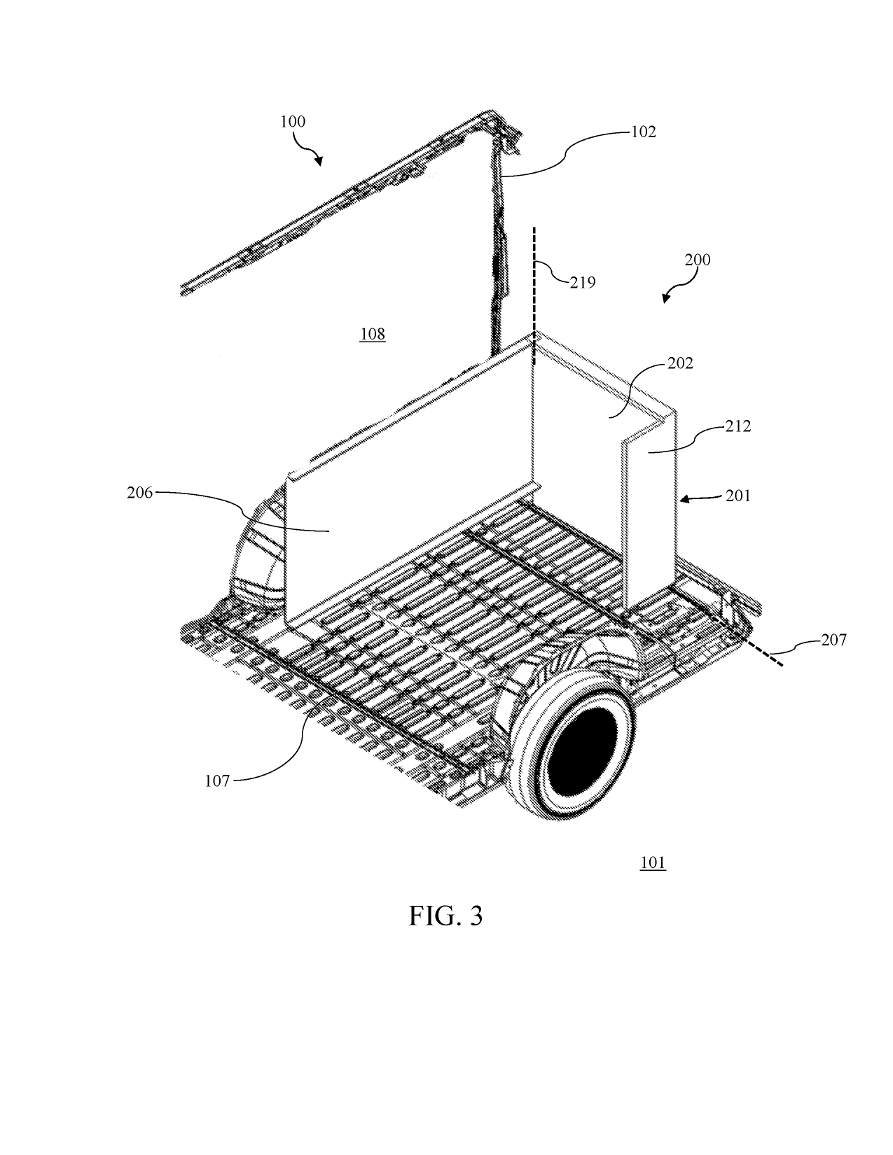

FIGS. 1-3 illustrate a vehicle (a full-size passenger van, although other vehicle types are contemplated) 100 with a first embodiment of a wheelchair ramp assembly 200 configured to deploy through a rear entrance 102, although it is contemplated that the ramp assembly 200 may be positioned to deploy through a side entrance (not shown) with similar results. Entrance 102 may provide access to the interior 108 of vehicle 100. The wheelchair ramp assembly 200 may be stowed in interior 108 as shown in FIG. 3 and deployed out of rear entrance 102 as shown in FIGS. 1-2. The wheelchair ramp assembly 200 comprises a platform assembly 201 which, in a deployed position of FIG. 1, defines a continuous surface or path 203 extending between the floor 107 of the vehicle 100 and the ground 101. The path 203 of the platform assembly 201 may be a single curved path or may include at least one turn 205, (as shown, a single 90° turn) that separates at least a first (curved or, as shown, linear) path portion 211 and a second (curved or, as shown, linear) path portion 213. The first path portion 211 and second path portion 213 are non-parallel, and may be oblique or, as shown in FIG. 1, generally perpendicular. The path 203 of the platform assembly 201 as shown, with its at least one turn 205, allows a wheelchaired passenger to depart the vehicle 100 from a rear entrance 102, turn, and exit to the right side of the vehicle 100 to the curb/sidewalk. Notably, it is contemplated that the at least one turn 205 could be in an opposite direction, whereby the wheelchair passenger would exit the platform assembly 201 to the left side of the vehicle 100 for use in left-hand traffic countries.

The platform assembly 201 may comprise a plurality of deployable platform sections. The platform assembly 201 shown in FIGS. 1-2 comprises two such sections: a first platform section 202 and a second platform section 206 that are moveable relative to each other and collectively define path 203 in their deployed positions.

A first edge 209 of the first platform section 202 may be hingedly coupled to the vehicle 100 adjacent the rear entrance 102, whereby the first platform section 202 pivots about pivot axis 207 between a stowed position in the interior 108 of the vehicle 100 and a deployed position outside of the vehicle 100. In its deployed position, first platform section 202 may define the first path portion 211 and/or turn 205 between its first edge 209 and its second edge 217. Pivot axis 207 may be horizontal and parallel to the plane of the rear entrance (door opening) 102, such that the first platform section 202 pivots approximately 90° between a generally horizontal, deployed position (see FIG. 1) and a generally vertical, stowed position (see FIG. 3). It is contemplated that the first platform section 202 could pivot more than 90°, whereby the first platform section 202 is inclined downwardly from the floor 107 of the vehicle 100. In alternative embodiments, the first platform section 202 may be slidingly coupled to the vehicle 100 such that it linearly slides out of the rear entrance 102 to deploy. Other known methods for deploying the first platform section 202 are contemplated.

A first edge 215 of the second platform section 206 may be hingedly coupled to a second edge 217 of the first platform section 202, whereby the second platform section 206 pivots about pivot axis 219 between a semi-stowed position and a deployed position. In its deployed position, the second platform section 206 is inclined downwards from the first platform section 202, whereby the second platform section 206 defines path portion 213 between its first edge 215 and its second edge 208. Pivot axis 219 is non-parallel to pivot axis 207 whereby the path portion 213 defined by the second platform section 206 extends non-parallel to path portion 211 defined by the first platform section 202. Second platform section 206 pivots upward about pivot axis 219 to the semi-stowed position. In the semi-stowed position, the second platform section 206 may be stacked flush/parallel/nested on top of the first platform section 202. In the disclosed embodiment, however, the second platform section 206 may be aligned generally normal to and generally vertically upwards from the first platform section 202 in the semi-stowed position, as shown in FIG. 2. In its fully stowed position, after the first platform section 202 pivots about pivot axis 207 into the interior 108 of the vehicle 100, the second platform section may be disposed on its side generally adjacent an inside wall of the vehicle 100, as shown in FIG. 3. In an alternative embodiment, the second platform section 206 may be slidingly coupled to the first platform section 202 such that the two sections 202, 206 are stacked parallel in their semi-stowed position and the second platform section 206 linearly deploys from the first platform section 202.

Any one or more of the platform sections, in their deployed position, may include supports extending between the platform section and the ground 101. For instance, as shown in FIG. 1, the first platform section 202 may be supported in its deployed position by one or more supports 204. The one or more supports 204 may have a stow condition and a deployed condition. As depicted in FIG. 1, the support 204 may be hingedly coupled to a bottom surface of the first platform section 202 whereby the support 204 may pivot between the deployed condition (extending vertically from the bottom surface to the ground 101) and the stowed condition (flush against the bottom surface). In some embodiments, one or more supports may be height adjustable to accommodate deployment of the ramp on uneven ground. The one or more supports may be deployed via a telescoping, linearly cascading, or ball screw mechanism. The one or more supports may be automatically deployed or manually set to a proper height by a driver of the vehicle 100.

In some embodiments, the first platform section 202 may be configured such that a top surface is at a lower elevation than the vehicle floor 107. To assist with transitioning from the first platform section 202 to the vehicle floor 107, a transition plate (not shown) may be provided to bridge the elevational gap.

As shown in FIG. 1, path portion 211 is defined by a single platform section (first platform section 202). In alternative embodiments, path portion 211 may be defined by multiple platform sections, any of which may be horizontal or inclined in their deployed position. Similarly, path portion 213 is defined by a single platform section (second platform section 206). In alternative embodiments, path portion 213 may be defined by multiple platform sections, any of which may be horizontal or inclined in their deployed position. See, for example, the second embodiment described herein. If more than one platform section is present for a given path portion, each platform section may be hingedly coupled to each other such that they fold out to define that path portion or slidingly coupled to each other such that they linearly deploy to define that path portion.

The platform assembly 201 may be provided with one or more winches 214, such as the inQline product sold by Q’Straint, to assist with ingress up and/or egress down an inclined portion of the platform assembly 201. The winch 214 may have a retractable webbing or other cable or strap with a connector 216 configured to engage a personal mobility device. The winch 214 may assist with traversing up the inclined portion 206. Additionally, the winch 214 may be configured to slowly release the retractable webbing to slowly guide a passenger down the inclined portion 206 when disembarking the vehicle 100. Two winches 214 may be provided with a singular joystick configured to actuate each winch independently such that the winches may respond to a directional input from the joystick and steer the passenger up or down an inclined portion of the platform assembly 201. In some embodiments, winch 214 may be attached to a top surface of the platform assembly 201. However, coupling the winch directly to the top surface of the platform assembly 201 will occupy the passengers maneuvering space. In other embodiments, the platform assembly 201 may be provided with a vertical support or wall 212 for supporting the winch 214 above the top surface of the platform assembly 201. As shown in FIG. 1, the vertical support 212 may extend upward from a third edge 223 of the first platform section 202 which is opposite its second edge 217, whereby the winch can pull a wheelchaired passenger up the second platform section 206.

A power source may be provided to automatically stow and deploy the wheelchair ramp assembly 200. The power source may be an electrical motor, hydraulic or pneumatic pump, or any other known power source in the art. Alternatively, the wheelchair ramp assembly 200 may be manually stowed or deployed by the driver of vehicle 100.

Although the wheelchair ramp assembly 200 is shown in FIGS. 1-3 mounted at a rear door opening 102, it is contemplated that it may be mounted at a side door opening, including a second row sliding door opening. In such a configuration, the second platform section 206 could be positioned against the back of the front row seats in the stowed position. With the platform assembly 201 deployed, the path 203, with its at least one turn 205, allows a wheelchaired passenger to depart the vehicle 100 from a side entrance, turn, and exit to the front of the vehicle 100. Notably, it is contemplated that the second platform section 206 could be mounted to an opposite side of the first platform section 202, whereby the wheelchair passenger would exit the platform assembly 201 to the rear of the vehicle 100.

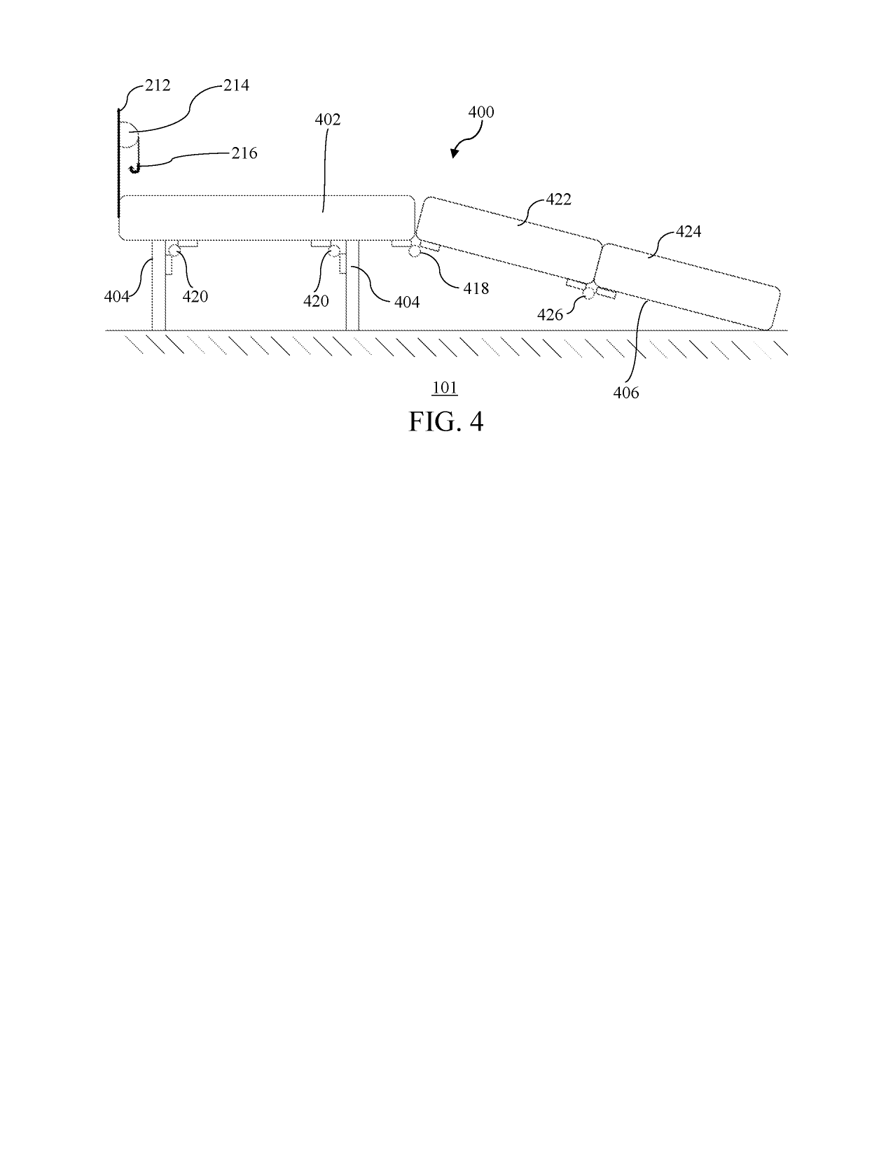

FIG. 4 illustrates a side view of the wheelchair ramp assembly 400 in the deployed position. In FIG. 4, the inclined portion 406 may be coupled to the horizontal portion 402 via a hinge 418. The inclined portion 406 may include a first inclined platform 422 and a second inclined platform 424. The first inclined platform 422 and second inclined platform 424 may be coupled via a hinge 426. More than two inclined platforms is contemplated. The supports 404 may be coupled to the horizontal portion 402 via a hinge 420.

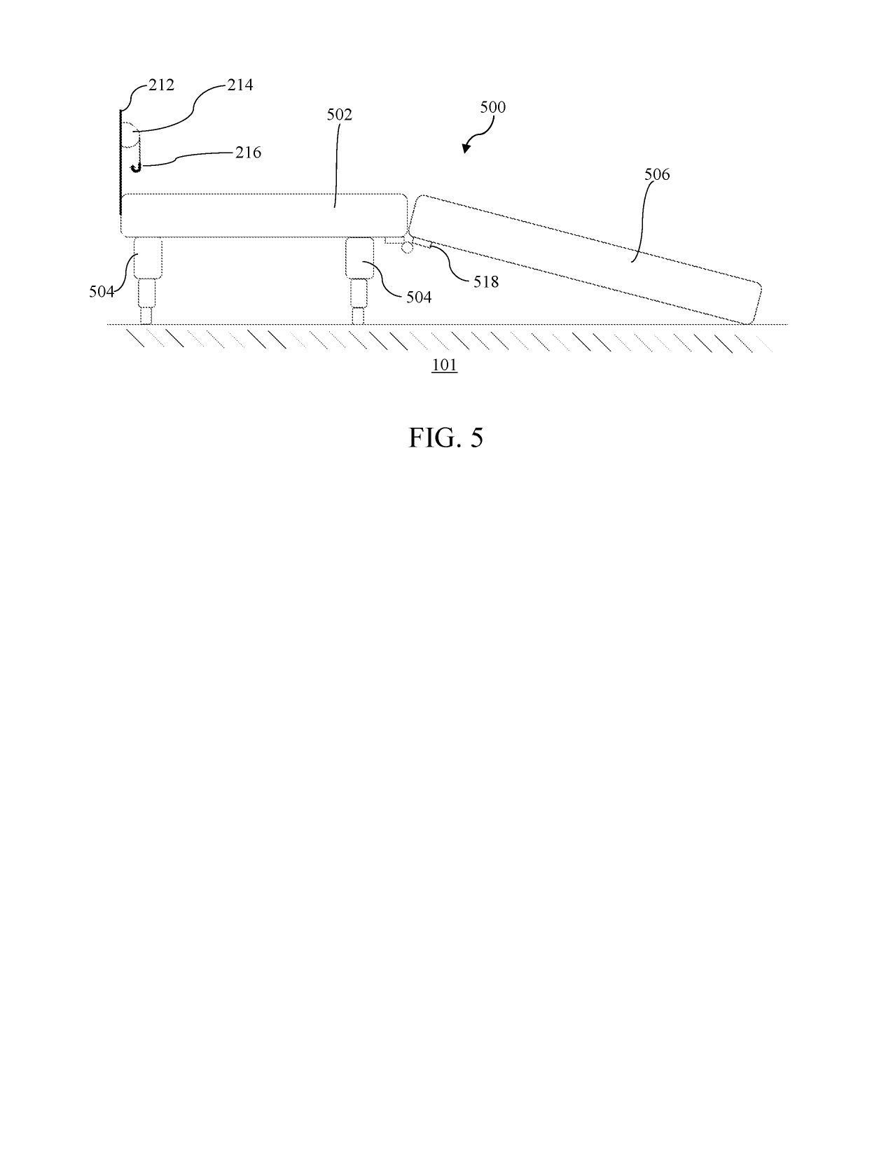

FIG. 5 illustrates a side view of a different configuration of the wheelchair ramp assembly 500 in the deployed position. The inclined portion 506 may be coupled to the horizontal portion 502 via a hinge 518.The supports 504 may be linearly adjusting parts that telescope or cascade to linearly deploy to the ground 101. The supports 504 may be manually deployed by an operator or electrically, pneumatically, or hydraulically deployed automatically. A platform level sensor may be coupled to the horizontal portion 502. The level sensor may be configured to send a signal to a controller indicating the horizontal portion 202 angle position such that the controller can automatically deploy the supports 204 to a height that makes the horizontal portion 202 within an acceptable level range.

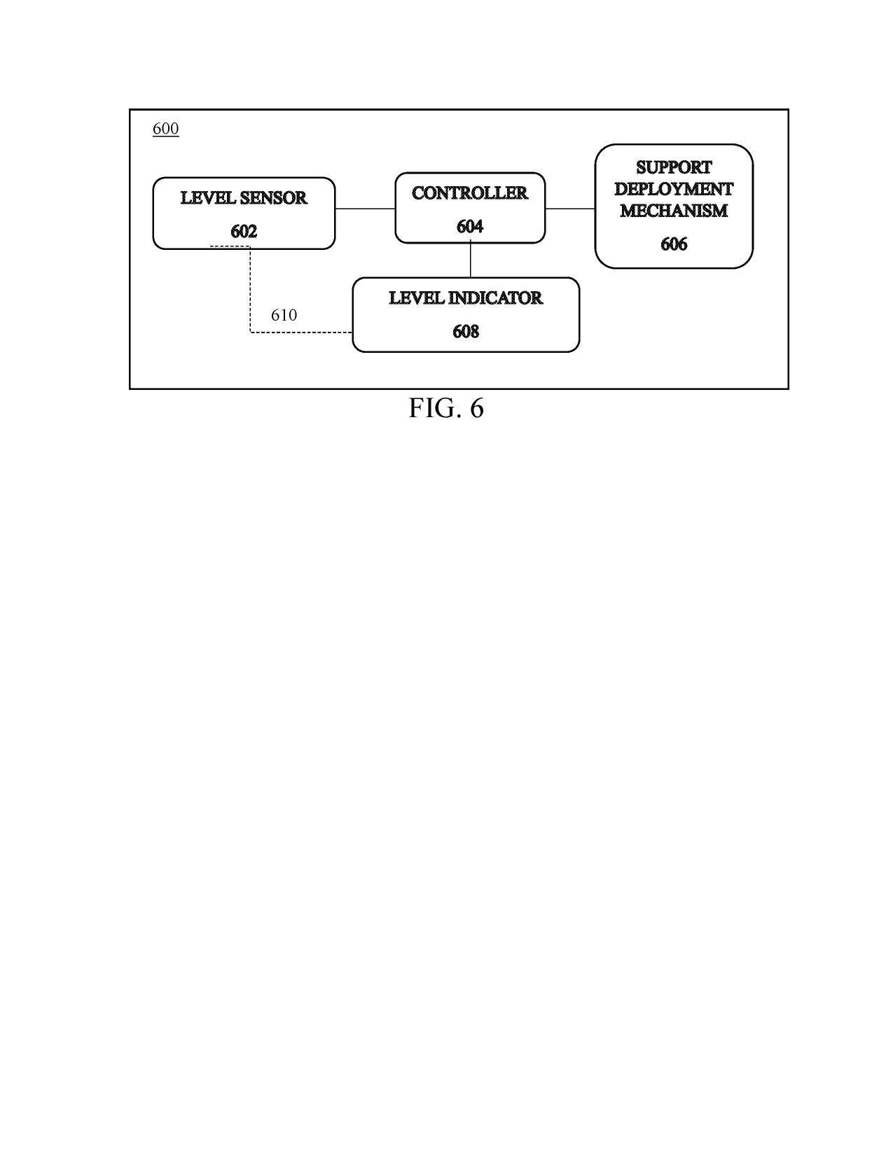

FIG. 6 illustrates electrical connections for a platform leveling system 400. A level sensor 602 may be mounted to the first platform section 202. The level sensor 602 may be configured to ascertain the levelness of the first platform section 202 in at least the forward direction F, or in a direction perpendicular to the forward direction F, or a combination thereof. The level sensor 602 may be electrically coupled to a controller 604. The level sensor 602 may be configured to send the levelness of the first platform section 202 to the controller 604. The controller 604 may be configured to receive the levelness of the first platform section 202 and execute simple algorithms to determine the magnitude of adjustment the supports 504 need to improve levelness of the first platform section 202. The controller 604 may be electrically coupled to a support deployment mechanism 606. The controller 604 may be configured to send a signal to the support deployment mechanism 566 to adjust the deployment height by a determined amount. The support deployment mechanism 606 may be an electric motor, hydraulic or pneumatic cylinder, or any other power source know to linearly deploy the supports 504. The level sensor 602 may be continuously monitoring the levelness of the first platform section 202 and sending signals to the controller 604 to determine if any readjustment is necessary. The controller 604 may further be electrically coupled to a level indicator 608. The controller 604 may determine when the first platform section 202 is in an acceptable range of levelness and may send a signal to the level indicator 608 to indicate the wheelchair ramp assembly 200 is safe to use. The level indicator 608 may be a screen with a word message or an LED light that may change colors, one color indicating a non-level first platform section 202 and another color for indicating a level first platform section 202.

Alternatively, the supports 504 may be manually adjusted by a driver of vehicle 100. In this configuration, the level indicator 608 may be electrically coupled to the level sensor 602 via connection 610. The horizontal portion level sensor 602 may be configured to send a levelness reading to the horizontal portion level indicator 608 to inform the driver of the adjustments needed to the supports 500.

While exemplary embodiments incorporating the principles of the present disclosure have been disclosed hereinabove, the present disclosure is not limited to the disclosed embodiments. Instead, this application is intended to cover any variations, uses, or adaptations of the disclosure using its general principles. Further, this application is intended to cover such departures from the present disclosure as come within known or customary practice in the art to which this disclosure pertains and which fall within the limits of the appended claims.

1. A vehicle access device for a vehicle, the vehicle access device comprising a platform assembly having a deployed position and a stowed position and defining a path for ingress and egress of a wheelchaired passenger, wherein the path is non-linear.

2. The vehicle access device of claim 1, wherein the path includes at least one turn.

3. The vehicle access device of claim 2, wherein the at least one turn separates at least a first path portion and a second path portion.

4. The vehicle access device of claim 3, wherein the first path portion is perpendicular to the second path portion.

5. The vehicle access device of claim 4, wherein the platform assembly comprises a first platform section configured to be coupled to the vehicle about a first pivot axis and a second platform section coupled to the first platform section about a second pivot axis.

6. The vehicle access device of claim 5, wherein the first pivot axis extends a first edge of the first platform section and the second pivot axis extends along a second edge of the first platform section.

7. The vehicle axis device of claim 6, wherein the first platform section is generally horizontal in the deployed position.

8. The vehicle access device of claim 7, wherein the first platform section is generally vertical in the stowed position.

9. The vehicle access device of claim 8, wherein the second platform section extends from the first platform section to a ground at an incline relative to the ground in the deployed position.

10. The vehicle access device of claim 8, wherein the second platform section is adjacent and generally parallel to an interior wall of the vehicle in the stowed position.

11. A vehicle access device for a vehicle comprising:
a substantially horizontal portion coupled to a vehicle adjacent a rear entrance on a first side of the horizontal portion;
an inclined portion coupled to the substantially on a second side of the horizontal platform;
wherein the first and second sides of the horizontal portion are substantially perpendicular.

12. The vehicle access device of claim 11, wherein the horizontal portion is substantially the same elevation as a floor of the vehicle.

13. The vehicle access device of claim 12, wherein the vehicle access device is configured to move between a stowed position inside the vehicle and a deployed position outside the vehicle.

14. The vehicle access device of claim 13, wherein the horizontal portion is hingedly coupled to the vehicle and configured to unfold to deploy.

15. The vehicle access device claim 14, further comprising one or more legs configured to support the horizontal portion.

16. The vehicle access device of claim 15, wherein the one or more legs are adjustable.

17. The vehicle access device of claim 15, wherein the one or more legs are automatically deployed and adjusted via a leg deployment motor.

18. The vehicle access device of claim 13, wherein the inclined portion is hingedly coupled to the horizontal portion.

19. The vehicle access device of claim 18, further comprising a winch system configured to assist a passenger in traversing the inclined portion.

20. A passenger vehicle modified to accommodate physically limited passengers comprising:
an accessibilityentrance configured to provide access to an interior cabin of the passenger vehicle;
a vehicle access device stowed in the interior cabin and deployed out of the rear entrance, the vehicle access device having:
a horizontal portion hingedly coupled to the vehicle on a first side of the horizontal portion;
an inclined portion coupled to the horizontal portion on a second side of the horizontal portion;
wherein the first and second sides of the horizontal portion are substantially perpendicular.
